(19) United States
(12) Patent Application Publication
(10) Pub. No.: US 2008/0291932 A1
(43) Pub. Date: Nov. 27, 2008

(54) Multi-protocol digital convergent system

(76) Inventor: Santosh Kumar Mukherjee, Bloomfield, NJ (US)

Correspondence Address: Ashok Tankha;Of Counsel, Lipton, Weinberger & Husick, 36 Greenleigh Drive, Sewell, NJ, 08080, US

(21) Appl. No.: 11/805,507

(22) Filed: May 22, 2007

(51) Int. Cl. H04L 12/56

(52) U.S. Cl. 370/410

(57) ABSTRACT

The system and method herein for multiprotocol switching comprises multiprotocol switching cards, a user registration module and a billing module. The multiprotocol switching cards are used for switching at the system level, network level and application level. The multiprotocol switching cards are inserted in a plurality of slots. The services are installed in each card though installation of software programs. The user registration module registers the subscribers for different communication identifiers such as land line, wireless phones and devices, and email. The billing module supports the billing and payment activities across multiple communication protocols. The disclosed invention transfers data across different communication channels such as local area networks, wireless networks, satellite network, cable network, time division multiplexing networks, voice networks, and asynchronous transfer mode networks, frame networks, internet protocol networks, data networks, etc. The transferred data is one of a voice, data, video and any combination thereof.

### BACKGROUND

Major data carriers typically operate over a range of communication modes, for example, wireline and wireless data communication modes. The data carriers use multiple transmission technologies and protocols necessitated by the most popular growth strategy in the telecommunication segment and by mergers and acquisitions. As a result, these data carriers require networking devices such as switches that handle multiple systems, networks, protocols and transmission technologies.

Customers prefer a seamless service irrespective of the types of network or technology that carries their traffic. A key differentiating factor for the carriers is to provide a converged environment that seamlessly connects and integrates multiple standards and communication platforms. Also, such a solution must be implemented in a scalable model making it affordable at any early stage and reducing the level of investment risk. Thus, the data carriers will still be able to use their legacy equipment in conjunction with next generation transmission technologies. Next generation technologies require systems and services that handle voice, video and data seamlessly that may be transmitted over media or networks such as wireline, wireless, etc.

Given the ubiquity of wireless devices, the preferred mode of access to a communication network is through a wireless network. As a communication network contains multiple transmission technologies, there is a need to converge or handshake between two transmission types, for example, between wireless and wireline communication modes.

Customers prefer simplified interfaces and unified methods of using different communication media or network types, such as wireline, wireless, etc. Hence, there is a need for a system that switches between these different communication media or networks, seamlessly and that provides a unified method of access and billing.

By providing a converged environment, service providers have the leverage of legacy systems and also integrate third party service providers' equipments and services with relative ease. Service providers will then be able to introduce new solutions and technologies rapidly to market.

There is a market need to provide a digital convergent switch (DCS) that converges the data at the system, network and application levels.

There is a market need to provide a billing solution that captures and aggregates the billing results on a per customer basis, irrespective of the communication media or network types used, and in some cases irrespective of the service providers. For example, there is a market need for a unified billing solution that provides a single billing result for using services across wireless, wireline, etc., communication media.

### SUMMARY OF THE INVENTION

The method and system herein addresses the above mentioned needs of a converged environment that seamlessly integrates different types of communication media such as wireless network, wireline network, satellite network, etc. that use multiple transmission technologies. The method and system herein addresses the need for providing a billing solution that captures and aggregates the billing results on a per customer basis, irrespective of the communication media or network types used, and irrespective of the service providers. The disclosed invention further addresses the need of a converged environment that enables the service providers to use legacy systems, third part equipments and services with relative ease.

The system and method herein for multiprotocol switching comprises a plurality of multiprotocol switching cards, a user registration module and a billing module. Each multiprotocol card enables convergence across different types of communication systems, networks and applications. The user registration module registers a subscriber's different communication identifiers such as land line, wireless phones, devices, e-mail, etc. The billing module supports the billing and payment activities of the subscriber across multiple communication protocols. The system for multiprotocol switching accepts and outputs traffic in different networks such as local area network, wireless network, satellite network, cable network, etc. The multiprotocol switching system also accepts from and outputs traffic to time division multiplexing networks, voice networks, asynchronous transfer mode networks, frame networks, internet protocol networks and data networks.

The system herein provides a digital convergent switch system (DCS) which is fully convergent, i.e., the DCS is a service provider and protocol independent and provides integration of disparate types of communication media at the point of convergence.

The system herein also provides a multiprotocol switch to converge or handshake between two different networks for data transfer between the two networks. The two networks may operate on different communication protocols.

The system herein also provides a switch that will enable subscribers to use regular communication features on their communication devices from a plurality of networks in a plurality of geographical areas.

The system herein also provides a multiprotocol switch to receive and transmit traffic from a wireless network, a wireline network and a data network.

The system herein also provides wireless customers with the ability to access disparate devices connected to the internet.

### BRIEF DESCRIPTION OF THE DRAWINGS

FIG. 1 exemplarily illustrates a convergent environment of plurality of communication media.

FIG. 2 exemplarily illustrates a system of a converged environment for a plurality of communication identifiers and networks for transferring different types of signals such as voice, video, and data signals.

FIG. 3 exemplarily illustrates a plurality of multiprotocol switching cards in a switching fabric of a digital convergent switch (DCS).

FIG. 4 exemplarily illustrates a digital convergent switch system.

FIG. 5 exemplarily illustrates service activities performed by the digital convergent switch.

FIG. 6 exemplarily illustrates the convergence flow diagram within the DCS.

FIG. 7 exemplarily illustrates a method for switching between a plurality of communication identifiers in a converged environment.

FIG. 8 exemplarily illustrates a DCS as a core convergence switch.

### DETAILED DESCRIPTION OF THE DRAWINGS

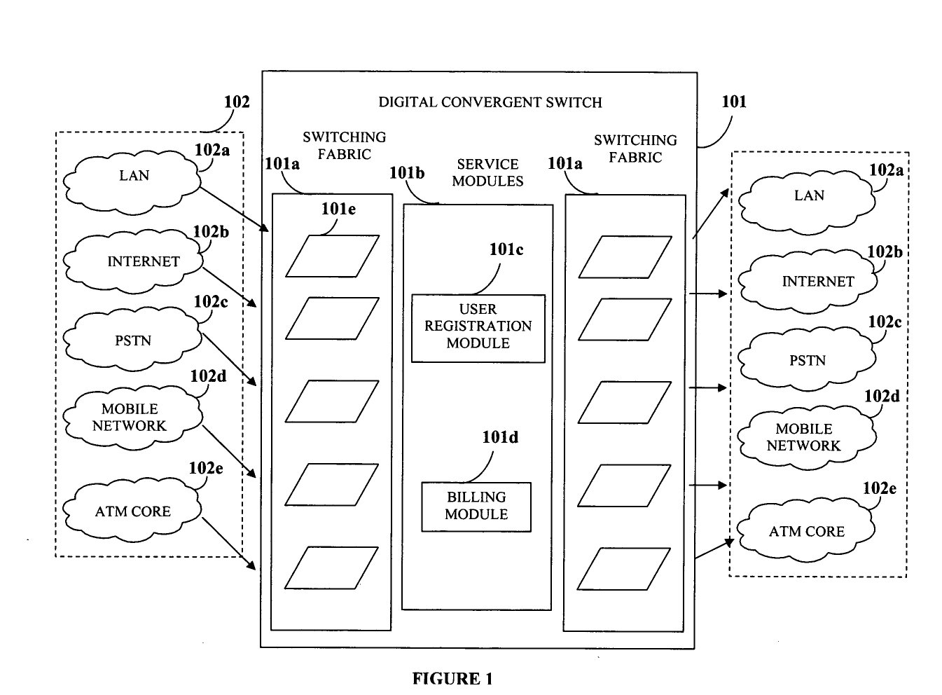

FIG. 1 exemplarily illustrates a convergent environment of a plurality of communication media. The convergent environment comprises a digital convergent switch (DCS) system 101 connected to a plurality of communication media. The DCS 101 is a small footprint switch and commands less real estate when collocated with other communication systems. The DCS 101 may be configured for multiple communication media such as local area network (LAN) 102a, internet 102b, PSTN 102c, mobile network 102d, ATM core 102e, etc. The DCS 101 contains a switching fabric 101a comprising multiple slots for inserting a plurality of multiprotocol switching cards 101e. Convergence of data from a first communication media or network to a second media or network in communication with the first media, occurs at three distinct levels in the following sequence: first at the system level, then at the protocol level and finally at the application level. At the system level, system level cards in the DCS 101 determine if the source and destination systems are compatible; if the source and destination level are not compatible, the system level card undertakes the system translation. For example, if Unix® is the source system that is communicating with a Microsoft Windows® system of Microsoft Inc., the system card in the DCS 101 undertakes the communication between the disparate systems. At the protocol level, the protocol level cards in the DCS 101 undertake protocol translation. For example, if wireless application protocol (WAP) is the source protocol then the WAP protocol card undertakes the communication between the disparate protocols. At the application level, the application level cards in the DCS 101 undertake application translation.

The DCS 101 is configured depending on the end application and the usage context. The DCS 101 is protocol independent and accepts multiple transmission protocols and outputs a variety of transmission protocols. One example of a protocol that the DCS 101 supports is the Audio Video Protocol (AVP). The AVP is used for multimedia communications over the internet. The AVP is based on a synchronisation scheme that does not include timestamps on transmitted information packets, thus reducing the header size of the transmitted AVP packet for efficient transmission. One object of AVP transmission is that multiple audio or audio-video frames are transmitted in the same AVP packet to reduce the packet rate, thus reducing the packet delivery delay. The AVP can achieve lower end-to-end message delay by putting multiple audio frames or mixed audio-video frames in the same AVP packet to reduce the packet rate. The DCS 101 also supports User Datagram Protocols (UDP) and real-time streaming protocol (RTSP). The UDP and RTSP are efficient for transferring audio files known as streaming files by compressing the audio files into small data packets.

Services are installed in each card of the switching fabric 101a through installation of software programs. Maintenance, troubleshooting and upgrades are undertaken remotely to reduce the costs, through a personal computer connected to the internet or through a mobile device connected to the internet. The DCS 101 further comprises service modules 101b used for subscriber registration and billing purposes.

A subscriber to the DCS 101 registers different communication identifiers such as landline, wireless phones and devices, e-mail, etc. with the DCS 101 using the user registration module 101c. Using a PC connected to the internet 102b or a wireless device connected to a mobile network 102d, depending on the usage scenario, the subscriber selects predetermined communication logic to be followed for convergence and communication configuration. For example, the subscriber may configure the DCS 101 to divert all calls from an office landline phone on a PSTN 102c to a wireless phone and if the subscriber is not available to receive the call, the call is diverted to a residence landline phone. The subscriber may also pre-configure e-mail delivery settings. For example, if the subscriber is travelling, e-mails from a certain client, converted in a short message service format (SMS) may be configured to be displayed on the mobile phone.

The DCS 101 is installed in a scalable model. The number of cards installed, the independent modules and the software programs installed on these cards depends on the user requirements and budget constraints. The management of the services, modules and other activities, such as setting a limit for the number of subscribers, etc., is conducted remotely via internet enabled devices, by an administrator of the DCS 101.

In one embodiment of the invention, the billing module 101d monitors incoming traffic and generates billing information. The DCS 101 is a complete convergent billing system, i.e., it supports the billing and payment activities across multiple systems, networks and communication protocols. The billing module 101d generates a consolidated bill and transmits it to the subscriber through a communication medium preferred by the subscriber, for example email, SMS, etc. The DCS 101 consolidates billing information from multiple billing points in a standardized format. The DCS 101 system also provides a browser based interface for accessing the standardized billing results. The convergence billing system is based on billing for the available media and the media under the same family.

The DCS 101 accepts and converges voice, data and video traffic. The DCS 101 also accepts, operates on and transmits traffic from different media and network architectures such as internet 102b, public switched telephone network (PSTN) 102c, mobile networks 102d an asynchronous transfer mode (ATM) core 102e and LAN 102a.

The DCS 101 further caters to multiple networks such as a time division multiplexing (TDM), voice network, asynchronous transfer mode (ATM), frame network, networks based on Internet protocol (IP), data network, etc. The DCS 101 platform manages call-control activities and multiple protocols from different switch applications. The PSTN 102c network has a high quality of service (QOS). The DCS 101 does not necessarily divert traffic away from PSTN 102c networks. On the other hand, the DCS 101 may be configured to use current PSTN 102c networks as a communication channel taking advantage of its high QOS. In one embodiment of the invention, the DCS 101 system is a common channel signalling system #7 (SS7) enabled. The SS7 enabled DCS 101 system routes and controls both voice and data. The SS7 connection in the DCS 101 follows a distributed network architecture.

The DCS 101 is controlled by a proprietary application programming interface (API). The DCS 101 enables telecommunication service providers to confidently use multiple vendors, overcoming problems associated with integrating multiple disparate systems. The DCS 101 converges and integrates the traffic from the systems of multiple vendors.

In one implementation, the DCS 101 may employ optical networking and connectivity technology to enable higher rates of data transmission. In another embodiment of the invention, the converging environment features may be implemented in the DCS 101 using embedded technology to incorporate certain minimum critical logic. In another embodiment of the invention, the DCS 101 may be implemented using the softswitch technology. The DCS 101 as a softswitch, provides the converging environment features entirely by means of software running on a computer.

In yet another embodiment of the invention, the DCS 101 contains input/output (I/O) adapters, wherein each I/O adapter transports data conforming to a plurality of protocols over an Ethernet connection. A plurality of drivers is required for the operation of networking equipment. The DCS 101 allows a plurality of drivers to access it.

An example of the usage of a convergent environment as implemented by DCS 101 is that of bus drivers operations. Apart from the primary task of driving a bus, a bus driver's job includes coordination activities like tracking the bus routing, schedule for changes in the route assigned, communicating with fellow drivers to solve minor problems, communicating with a central office or dispatch office to solve other problems, etc. The dispatch office has to respond to requests for information and queries by the drivers as information may not be available to the driver onboard the bus. The conventional arrangement for accomplishing the above mentioned tasks include hardware such as cellular phones, computers, fax machines and two way radios. The software applications used in the conventional system included Microsoft Office® and Microsoft Word®. In the conventional system, communication and coordination activities are transmitted through the dispatch office. If two drivers need to communicate, then the dispatch office may be involved to forward the message from one of the drivers to the other. The intervention of the dispatch office may be undesirable especially for minor problems and discrepancies.

A real time communication system for point to point communication between drivers themselves and the dispatch office may be established in a convergent environment using the DCS 101. A database for route scheduling in the dispatch office may be used unlike the paper version in the conventional system. A database may be used in each of the buses for temporarily storing information about mechanical malfunctions. Further a display system in each of the buses may be used for maps and manuals display. A global positioning system (GPS) in each of the buses may be used to locate and estimate the buses' arrival time. Two way communication systems with wireless equipments may be used to enable communication between the dispatch office and the buses. The DCS 101 converges the data and signals from the above mentioned numerous source devices from the buses and the dispatch office and delivers output data to a destination device functionally different from the source device. For instance, information regarding the exact geographical location of the bus may be transmitted from the GPS receiver in the bus in the form of a short message to a cellular phone in the dispatch office. The communication system based on the DCS 101 provides services such as online route scheduling and display, onboard storage of messages, display for visual instructions and maps.

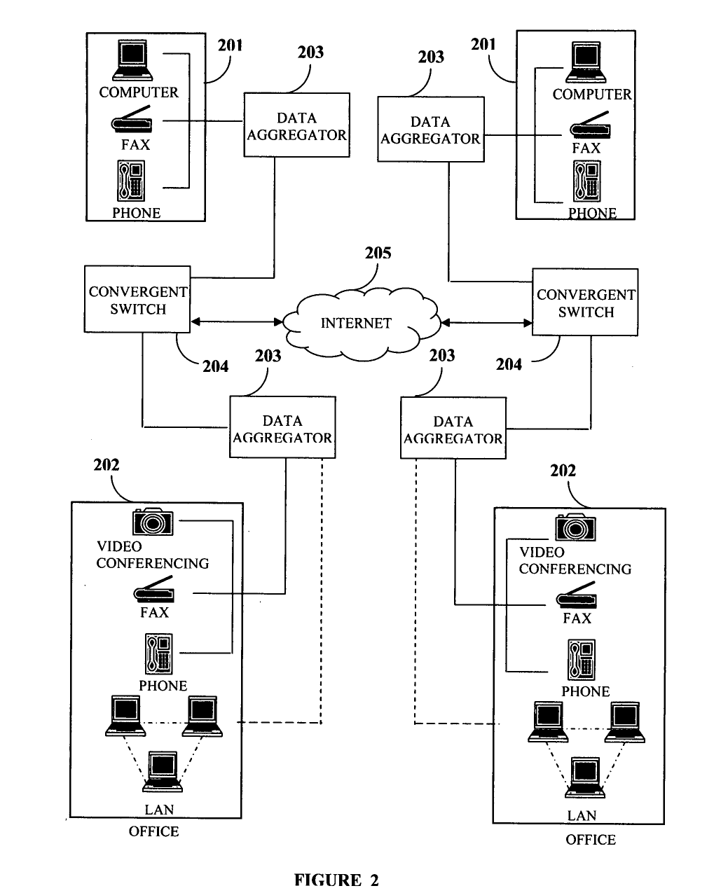

FIG. 2 exemplarily illustrates a system of a converged environment for a plurality of communication identifiers and networks for transferring different kinds of signals such as voice, video, and data signals. In a home network 201 or in an office network 202, the devices such as phone, fax, video camera, etc. interconnected in a local area network (LAN) are connected to a data aggregator 203. The data aggregator 203 helps in the assimilation of different types of signals transferred to or from these devices. The data aggregator 203 in turn is connected to the DCS 101 that is in communication with the Internet 204. The DCS 101 helps in converging the signals coming from different networks and transferring these signals to the desired destination over the existing network.

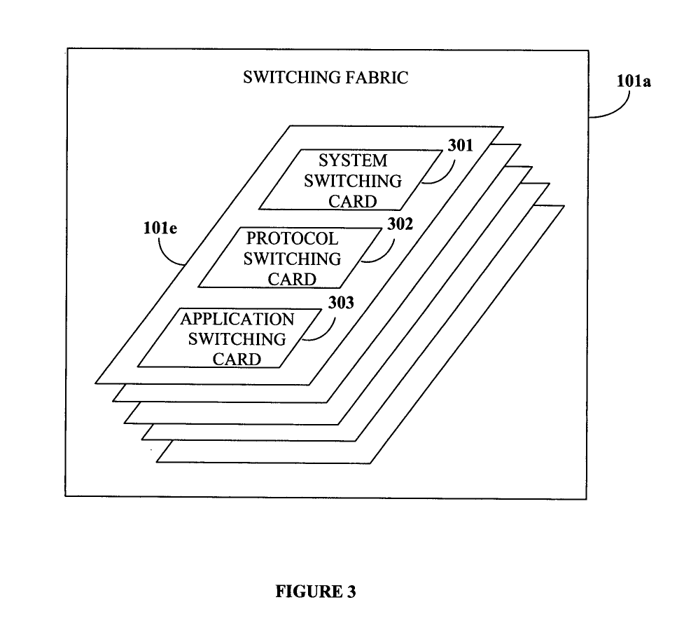

FIG. 3 exemplarily illustrates a plurality of multiprotocol switching cards 101e in a switching fabric 110a of a DCS 101. The DCS 101 contains a switching fabric 110a comprising multiple slots in which a plurality of multiprotocol switching cards 101e are inserted. Each multiprotocol switching card 101e comprises a system switching card 301, a protocol switching card 302, and an application switching card 303. The switching fabric 110a supports different topologies for connecting disparate communication media. In one implementation, the switching fabric 110a may support redundant, dual homed connection for scalable and fault tolerant meshed topology. The switching fabric 110a facilitates convergence switching in real-time leading to improved switching performance.

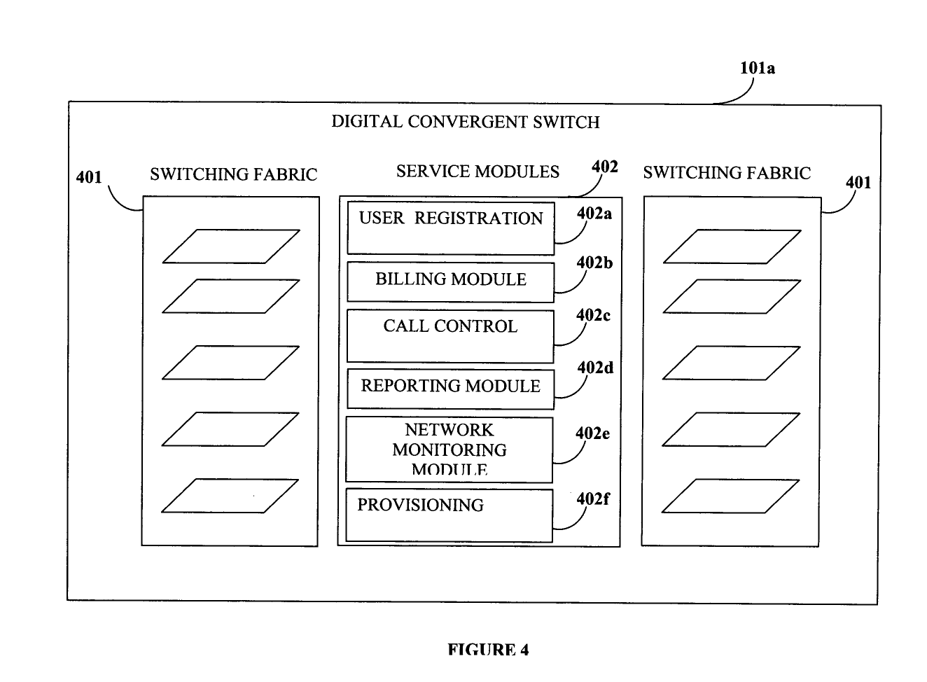

FIG. 4 exemplarily illustrates a digital convergent switch (DCS) system 101. A subscriber registers different communication identifiers such as landline, wireless phones and devices, email, etc., using a user registration module 402a. A billing module 402b supports the billing and payment activities across multiple communication protocols. A call control module 401c manages the call control activities of traffic in the DCS 101. A reporting module 402d reports the billing results to the service provider of the applications and services installed on the DCS 101. A network monitoring module 402e monitors the performance of the network in which the DCS 101 is located. A provisioning module 402f is used for provisioning new services on the DCS 101.

FIG. 5 illustrates the details of the service activities performed by the digital convergent switch system. FIG. 5 shows convergence switching over a standard Ethernet 501 network. The DCS 101 converges management activities, networking activities, and clustering activities. The DCS 101 consists of the following three components: the clustering block 502 for the purpose of high performance server clustering over the communication network, a storage network block 503 for block storage networking, and a remote management block 504 for remotely managing the clustering of high performance servers over the network.

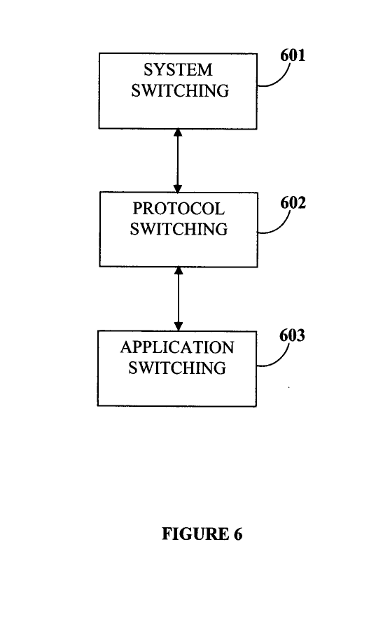

FIG. 6 illustrates the convergence flow diagram within the DCS 101. Convergence occurs in the DCS 101 at three distinct levels in the following sequence: first at the system level 601, then at the protocol level 602 and finally at the application level 603.

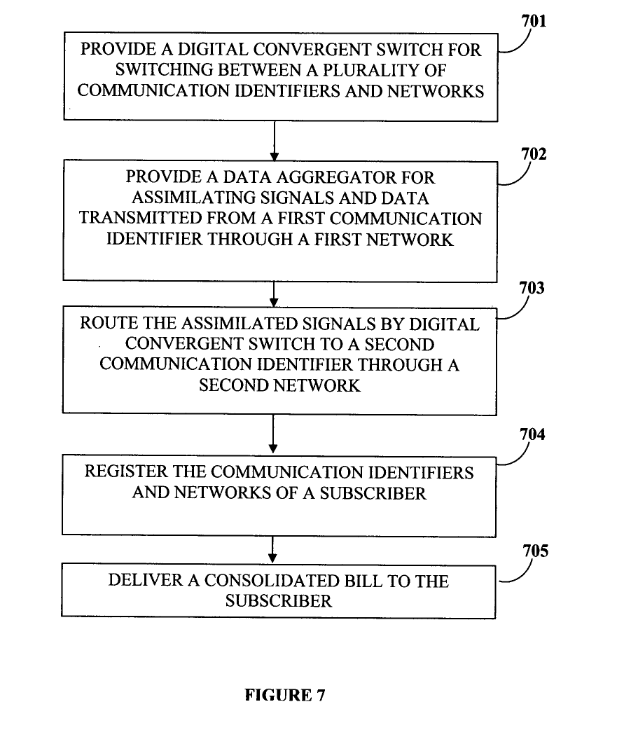

FIG. 7 exemplarily illustrates a method for switching between a plurality of communication identifiers in a converged environment. For enabling switching and communication between a plurality of communication identifiers in a converged environment a DCS 101 is provided 701. The DCS 101 converges signals from a plurality of communication identifiers on a network and transmits the signals to a destination communication identifier on another network 701. A data aggregator 203 is provided for assimilating different signals and data transmitted from a first communication identifier through a first network 702. Routing of the assimilated signals and data to a second communication identifier through a second network 703 is accomplished by the DCS 101. For example, a first communication identifier may be a cellular phone operating via a first network, i.e., cellular network using wireless technology. The cellular phone sends voice data to a second communication identifier that may be a computer connected to the internet. The data aggregator 203 assimilates voice data from the cellular phone and outputs the data to the DCS 101. The DCS 101 routes the assimilated signals to the computer connected to the internet, using the Voice over Internet Protocol (VoIP). The communication identifiers of a subscriber are registered 704 with the DCS 101 using a user registration module 101c. Subsequent to the usage of converging services of the DCS 101, a consolidated bill is generated. The bill includes the tariff for each type of service subscribed and is delivered to the subscriber by a communication medium preferred by the subscriber 705.

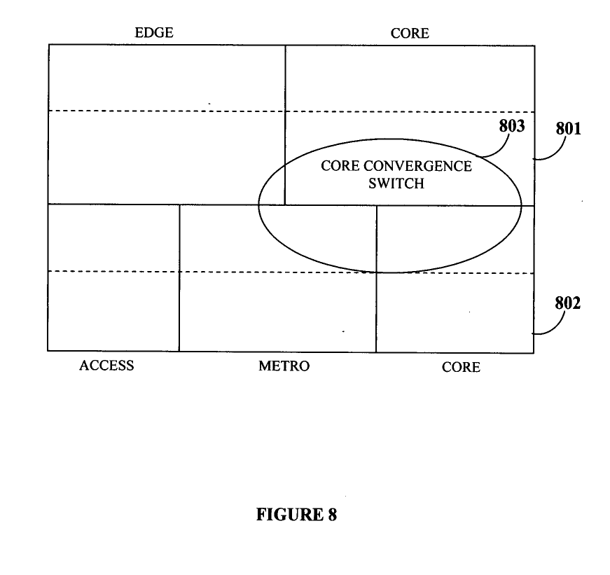

FIG. 8 exemplarily illustrates a DCS 101 as a core convergence switch 803. The core conversion switch 803 is usually used as a bandwidth manager or a switch for multiprotocol label switching (MPLS). However, the core convergence switches 803 may be designed for metro core. The largest point of presence (POP) carriers operate in each metro, where bandwidth is aggregated, switched, and put onto long-haul backbones. The core convergence switches are spread over two layers as shown in the FIG. 8. The two layers are service layer 801 and transport layer 802.

The core convergence switches 803 are provided for simplifying a metro core office by integrating the functions of transport switching and data switching on a scaleable platform with a common control plane.

Due to the over crowded metro core offices, the carriers usually consume a large amounts of rack space, power, and network element ports in order to make the appropriate connections among metro and long-haul network. The metro core offices house a mixture of edge routers, core routers, asynchronous transfer mode (ATM) switches, synchronous optical networking (SONET) add-drop multiplexers (ADM), dense wavelength division multiplexing (DWDM) equipment, digital cross-connects, and, in some cases, SONET switching systems. Making a connection through the metro core offices requires a large number of fiber jumpers, hands-on cabling and connecting, and many different interactions with a network management system. By using a core convergence switch 803 there is a reduction in the number of fiber jumpers, reduction in the hands-on cabling and connection, for a more simplified, two layered approach.

It will be readily apparent that the various methods and algorithms described herein may be implemented in a computer readable medium, e.g., appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A “processor” means any one or more microprocessors, Central Processing Unit (CPU) devices, computing devices, microcontrollers, digital signal processors, or like devices. The term “computer-readable medium” refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during Radio Frequency (RF) and Infrared (IR) data communications. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product comprising computer executable instructions embodied in a computer-readable medium comprises computer parsable codes for the implementation of the processes of various embodiments.

The present invention can be configured to work in a network environment including a computer that is in communication, via a communications network, with one. or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel.RTM., Pentium.RTM., or Centrino.TM. processor, that are adapted to communicate with the computer. Any number and type of machines may be in communication with the computer.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects

I claim:

1. A system for switching between a plurality of communication identifiers and networks in a converged environment, comprising:
a digital convergent switch, wherein said digital convergent switch further comprises:
a plurality of multiprotocol switching cards for providing networking, storage, clustering, and remote management activities;
a switching fabric, wherein said plurality of multiprotocol switching cards are connected to said switching fabric;
a user registration module for registering the communication identifiers and the networks on said converged environment, by a subscriber;
a billing module in communication with said user registration module for supporting billing and payment activities across multiple communication protocols; and
a data aggregator for assimilating different types of data and signals generated by said communication identifiers and transmitted through said networks.

2. The system of claim 1, wherein said multiprotocol switching card further comprises a system switching card, a protocol switching card and an application switching card to converge signals and data from said communication identifiers and networks at the corresponding levels.

3. The system of claim 1, wherein said communication identifiers may be one of a wired and a wireless communication device.

4. The system of claim 1, wherein said network may be one of a wired and a wireless network.

5. The system of claim 1 is connected to a monitoring centre to provide a browser based user interface for managing said services on said plurality of multiprotocol switching cards.

6. The system of claim 1, wherein said plurality of multiprotocol switching cards comprise service applications to provide predetermined services to a subscriber.

7. The system of claim 1, wherein said multiprotocol switching cards are protocol independent and the multiprotocol switching cards transmit data conforming to a variety of transmission protocols.

8. The system of claim 1, wherein said billing module generates a consolidated bill and transmits said consolidated bill to said subscriber in a medium of communication preferred by the subscriber.

9. The system of claim 1, further comprising a call control module for managing call control activities of voice traffic.

10. The system of claim 1, further comprising a reporting module for reporting billing results to a service provider of the predetermined services.

11. The system of claim 1, further comprising a network monitoring module for monitoring the performance of the network connected to said digital convergent switch.

12. The system of claim 1, further comprising a provisioning module for provisioning new services on said plurality of multiprotocol switching cards.

13. The system of claim 1 accepts traffic from and outputs traffic to time division multiplexing networks, voice networks, and asynchronous transfer mode networks, frame networks, internet protocol networks and data network.

14. The system of claim 1, wherein an open programmable architecture is used for said converged environment.

15. The system of claim 1, wherein a SS7 connection is provided in the form of distributed network architecture, on said converged environment.

16. The system of claim 1, wherein said billing module consolidates billing information from multiple billing points into a standardized format.

17. The system of claim 1, wherein said billing module switching comprises a browser based user interface for accessing standardized billing results.

18. A method for switching between a plurality of communication identifiers and networks in a converged environment comprising the steps of:
providing a digital convergent switch for switching between said plurality of communication identifiers and said networks;
providing a data aggregator for assimilating signals and data transmitted by a first communication identifier through a first network;
routing said assimilated signals by said digital convergent switch to a second communication identifier through a second network;
registering the communication identifiers and the networks of a subscriber with the digital convergent switch; and
delivering a consolidated bill to said subscriber for converging services of the digital convergent switch.

19. The method of claim 18, wherein said step of delivering a consolidated bill to said subscriber is carried out by a delivery means specified by the subscriber and is one of an electronic mail, a postal mail, a short message service and any combination thereof.

20. A computer program product comprising computer executable instructions embodied in a computer-readable medium, said computer program product comprising:
a first computer parsable program code for assimilating different types of signals and data transmitted by a first communication identifier through a first network;
a second computer parsable program for routing said assimilated signals by a digital convergent switch to a second communication identifier through a second network;
a third computer parsable program code for registering the communication identifiers and networks of a subscriber with said digital convergent switch; and
a fourth computer parsable program code for delivering a consolidated bill to said subscriber for converging services of the digital convergent switch.

21. The computer program product of claim 20, further comprising a fifth computer parsable program code for providing predetermined services to a subscriber.

22. The computer program product of claim 20 further comprising a sixth computer parsable program code for reporting billing results to a service provider of the predetermined services.

23. The computer program product of claim 20, further comprising a seventh computer parsable program code for generating a consolidated bill and transmitting said consolidated bill to the subscriber in a medium of communication preferred by the subscriber.
